(19) United States
(12) Patent Application Publication
(10) Pub. No.: US 2024/0004505 A1
(43) Pub. Date: Jan. 4, 2024

(54) CONDUCTIVE FILM

(71) Applicant: FUJIFILM Corporation, Tokyo (JP)

(72) Inventor: Hideki TOMIZAWA, Kanagawa (JP)

(73) Assignee: FUJIFILM Corporation, Tokyo (JP)

(21) Appl. No.: 18/327,733

(22) Filed: Jun. 1, 2023

(30) Foreign Application Priority Data
Jun. 30, 2022 (JP) 2022-105430

(51) Int. Cl. G06F 3/044; B32B 27/08; B32B 27/40

(52) U.S. Cl. CPC G06F 3/0446; B32B 27/08; B32B 2457/208; G06F 2203/04103; G06F 2203/04112; B32B 27/40

(57) ABSTRACT

Provided is a conductive film having excellent conductivity in a case where a bending test is carried out after storage in a high-temperature and high-humidity environment. The conductive film includes a resin base material, a copper wire that is disposed on the resin base material, and a coating layer that covers a surface of the copper wire, where the coating layer contains a metal nanowire and a hydrophobic resin.

### CROSS-REFERENCE TO RELATED APPLICATIONS

The present application claims priority under 35 U.S.C. § 119 to Japanese Patent Application No. 2022-105430 filed on Jun. 30, 2022. The above application is hereby expressly incorporated by reference, in its entirety, into the present application.

### BACKGROUND OF THE INVENTION

### 1. Field of the Invention

The present invention relates to a conductive film.

### 2. Description of the Related Art

A conductive base material having a conductive thin wire (a thin wire-shaped wire line that exhibits conductivity) is widely used in various use applications in, for example, a touch panel, a solar cell, and an electro luminescence (EL) element. In particular, in recent years, the mounting rate of touch panels on mobile phones and mobile game devices has been increasing, and the demand for the conductive base material for a capacitance type touch panel that makes multi-point detection possible is rapidly expanding.

For example, JP2015-211167A describes an invention related to a manufacturing method for an electrical wiring member having a base material, a metal layer selectively which is formed on a main surface of a base material and has a blackened upper surface and a blackened side surface, and a non-fluid photoresist layer which is formed on an upper surface and a side surface of the metal layer and is partially removed.

### SUMMARY OF THE INVENTION

As a result of preparing a conductive base material having a conductive thin wire with reference to JP2015-211167A and studying the application of the conductive base material to a wiring board that requires flexibility, the inventors of the present invention found that in a case where a conductive base material stored in a high-temperature and high-humidity environment is bent, the conductivity of the metal wire formed on the base material may decrease.

In consideration of the above circumstances, an object of the present invention is to provide a conductive film having excellent conductivity in a case where a bending test is carried out after storing the conductive film in a high-temperature and high-humidity environment.

As a result of diligent studies to solve the above-described problems, the inventors of the present invention completed the present invention. That is, the inventors of the present invention found that the above-described problems can be solved by the following configurations.
[1] A conductive film comprising:
a resin base material;
a copper wire that is disposed on the resin base material; and
a coating layer that covers a surface of the copper wire, in which the coating layer contains a metal nanowire and a hydrophobic resin.
[2] The conductive film according to [1], in which the metal nanowire contains copper.
[3] The conductive film according to [1] or [2], in which the metal nanowire has a diameter of 20 to 150 nm.
[4] The conductive film according to [1] or [2], in which the metal nanowire has a length of 5 to 200 μm.
[5] The conductive film according to [1] or [2], in which a content of the metal nanowire is 10% to 40% by mass with respect to a total mass of the coating layer.
[6] The conductive film according to [1] or [2], in which the hydrophobic resin has a tricyclodecane structure.
[7] The conductive film according to [1] or [2], in which the hydrophobic resin includes a polyurethane resin.
[8] The conductive film according to [1] or [2], in which a thickness of a region of the coating layer, the region being disposed on a surface of the copper wire on a side opposite to a surface facing the resin base material, is 1 to 10 μm.
[9] The conductive film according to [1] or [2], in which a thickness of a region of the coating layer, the region including a direction in which the copper wire extends and being disposed on a surface intersecting a surface facing the resin base material, is 1 to 10 μm.

According to the present invention, it is possible to provide a conductive film having excellent conductivity of a metal wire in a case where a bending test is carried out after storing the conductive film in a high-temperature and high-humidity environment.

### BRIEF DESCRIPTION OF THE DRAWINGS

FIG. 1 is a schematic perspective view illustrating an example of a configuration of a conductive film according to the present invention.

FIG. 2 is a schematic cross-sectional view illustrating an example of the configuration of the conductive film according to the present invention.

FIG. 3 is a plan view illustrating an example of a mesh pattern formed from conductive thin wires of the conductive film according to the present invention.

### DESCRIPTION OF THE PREFERRED EMBODIMENTS

Hereinafter, the present invention will be described in detail.

The description of the following configuration requirements is made based on representative embodiments of the present invention in some cases; however, the present invention is not limited to the embodiments.

Hereinafter, the meaning of each description in the present specification will be described.

In the present specification, a numerical value range represented by “to” means a range including numerical values before and after “to” as a lower limit value and an upper limit value.

Regarding numerical value ranges that are described stepwise, an upper limit or lower limit described in a certain numerical value range may be replaced with an upper limit or lower limit of another stepwise numerical value range. In addition, in a numerical value range described in the specification, an upper limit or lower value described in a certain numerical value range may be replaced with a value shown in Example.

The “step” includes not only an independent step but also a step that cannot be clearly distinguished from other steps, as long as the intended purpose of the step is achieved.

Unless otherwise specified, an angle including “orthogonal”, “parallel”, or the like shall include an error range generally allowed in the related technical field.

“Transparent” means that the light transmittance is at least 40% or more in a wavelength range of visible light of 400 to 800 nm, where the light transmittance is preferably 75% or more, more preferably 80% or more, and still more preferably 90% or more. The light transmittance is measured by using “Plastics—Determination of total light transmittance and total light reflectivity” specified in JIS K 7375: 2008.

In the present specification, “(meth)acrylate” represents one or both of acrylate and methacrylate, “(meth)acrylic acid” represents one or both of acrylic acid and methacrylate, and “(meth)acryloyl” represents one or both of acryloyl and methacryloyl.

“Alkali-soluble” means that the solubility in 100 g of an aqueous solution of 1% by mass sodium carbonate at 22° C. is 0.1 g or more. That is, the “alkali-soluble resin” means a resin that satisfies the above-described solubility.

“Water-soluble” means that the solubility in 100 g of water having a liquid temperature of 22° C. and a pH of 7.0 is 0.1 g or more. That is, the “water-soluble resin” means a resin that satisfies the above-described solubility.

The “solid content” of a composition means components that form a composition layer (for example, a photosensitive composition layer, an interlayer, or a thermoplastic resin layer) that is formed of the composition, and in a case where the composition contains a solvent (for example, an organic solvent or water), the solid content means all the components excluding the solvent. In addition, in a case where the components are components that form a composition layer, the components are considered to be the solid content even in a case where they are liquid components.

In the present specification, in a case where there are a plurality of substances corresponding to each component in the composition, the amount of each component in the composition means the total amount of the plurality of substances present in the composition unless otherwise p specified.

Unless otherwise specified, the weight-average molecular weight (Mw) and the number-average molecular weight (Mn) in the present specification are molecular weights converted using polystyrene as a standard substance, which are obtained by measuring with a gel permeation chromatography (GPC) analytical apparatus using TSKgel GMHxL, TSKgel G4000HxL, and TSKgel G2000HxL and/or TSKgel Super HZM-N (product names, all manufactured by TOSOH CORPORATION) as columns, tetrahydrofuran (THF) as a solvent, and a differential refractometer as a detector.

In the present specification, unless otherwise specified, the molecular weight of a compound having a molecular weight distribution is the weight-average molecular weight (Mw).

In addition, in the present specification, the dispersivity (also referred to as the polydispersity) is a ratio Mw/Mn of a weight-average molecular weight (Mw) and a number-average molecular weight (Mn).

In the present specification, the “exposure” includes not only exposure using light but also drawing with particle beams such as electron beams and ion beams, unless otherwise specified. In addition, examples of the light that is used for exposure generally include a bright line spectrum of a mercury lamp, a far ultraviolet ray represented by an excimer laser, and an actinic ray (an active energy ray) such as an extreme ultraviolet ray (extreme ultraviolet lithography (EUV) light), or an X-ray.

In the present specification, the “main chain” means a relatively longest bonding chain in a polymer, and the “side chain” means a molecular chain branched from the main chain.

In the present specification, unless otherwise specified, the rate of the constitutional unit of the polymer is in terms of a molar ratio.

Further, in the present specification, a combination of two or more preferred aspects is a more preferred aspect.

Conductive Film

A conductive film according to the embodiment of the present invention (hereinafter, also simply referred to as a “conductive film”) contains a resin base material, a copper wire that is disposed on the resin base material, and a coating layer that covers a surface of the copper wire, where the coating layer contains a metal nanowire and a hydrophobic resin.

In such a conductive film, the conductivity of the metal wire (copper wire) in a case where a bending test is carried out after storing the conductive film in a high-temperature and high-humidity environment is excellent (hereinafter, also referred to as “the effect of the present invention is excellent”).

More specifically, in the conductive film according to the embodiment of the present invention, the electrical connection between both ends of a thin copper wire that constitutes the copper wire (hereinafter, also referred to as “conductive connectivity”) is maintained even after storing the conductive film in a high-temperature and high-humidity environment and subsequently carrying out a bending test.

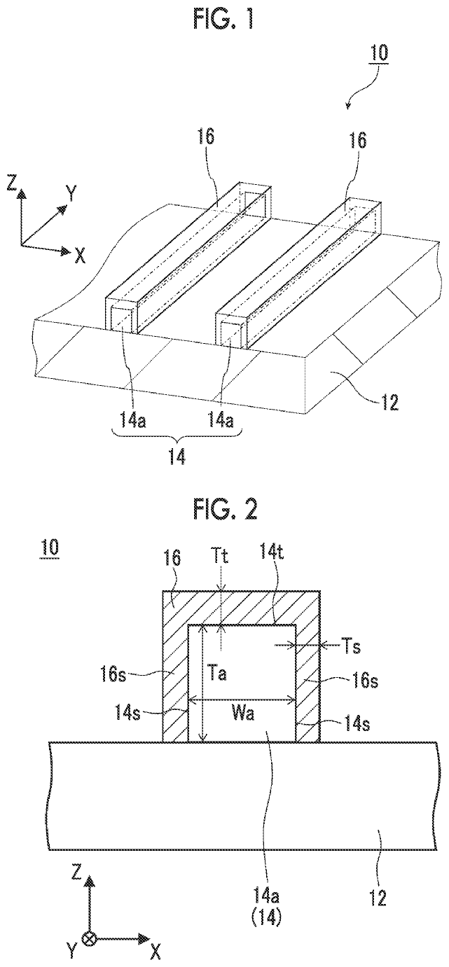

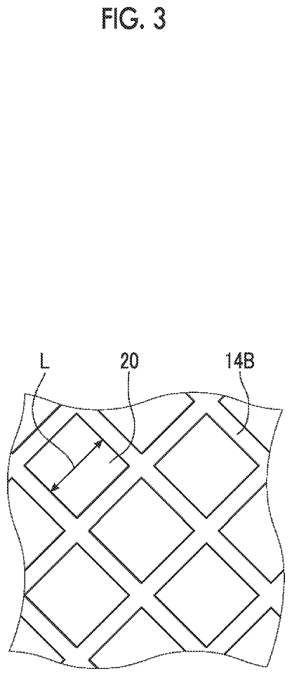

FIG. 1 is a schematic perspective view illustrating an example of a configuration of a conductive film according to the embodiment of the present invention, and FIG. 2 is a schematic cross-sectional view illustrating an example of the configuration of the conductive film according to the embodiment of the present invention.

A conductive film 10 illustrated in FIG. 1 has a resin base material 12, a copper wire 14 that is disposed on the resin base material 12, and a coating layer 16 that covers a surface of the copper wire 14. It is noted although two thin wire-shaped members (hereinafter, also referred to as “thin copper wires”) 14a that constitute the copper wire 14 and extend in one direction are illustrated in FIG. 1. The disposition form of the copper wire and the number thereof are not particularly limited.

In addition, as illustrated in FIG. 2, the coating layer 16 that covers the surface of the thin copper wire 14a (the copper wire 14) contains a metal nanowire and a hydrophobic resin, which are not illustrated in the drawing.

Hereinafter, the normal direction with respect to the main surface of the resin base material (the z-axis direction in FIG. 1 and FIG. 2) is also referred to as a “lamination direction”, a direction in which the thin copper wire that constitutes the copper wire extends (the y-axis direction in FIG. 1 and FIG. 2) is also referred to as an “extending direction”, and a direction orthogonal to both the lamination direction and the extending direction (the x-axis direction in FIG. 1 and FIG. 2) is also referred to as a “width direction”.

Resin Base Material

The resin base material may be any member as long as it contains a resin and can support the copper wire and the coating layer, and the kind of resin to be contained is not particularly limited.

The resin base material is preferably a base material having flexibility from the viewpoint that a conductive film to be obtained has excellent bendability. Examples of the base material having flexibility include a base material consisting of a thermoplastic resin.

Examples of the resin that constitutes the resin base material include resins having a melting point or glass transition temperature of about 290° C. or lower, such as polyethylene terephthalate (PET) (258° C.), polycycloolefin (134° C.), polycarbonate (250° C.), an acrylic film (128° C.), polyethylene naphthalate (269° C.), polyethylene (135° C.), polypropylene (163° C.), polystyrene (230° C.), polyvinyl chloride (180° C.), polyvinylidene chloride (212° C.), and triacetyl cellulose (290° C.), where PET, polycycloolefin, or polycarbonate is preferable. Among the above, PET is more preferable since it has excellent adhesiveness to the conductive thin wire. The numerical value in the brackets is the melting point or the glass transition temperature.

The total light transmittance of the resin base material is, for example, 70% to 100%, and it is preferably 85% to 100%. The total light transmittance is measured using “Plastics —Determination of total light transmittance and total light reflectivity” specified in Japanese Industrial Standards (JIS) K 7375: 2008.

The thickness of the resin base material is not particularly limited, and it is, for example, 25 to 500 μm in a large number of cases, where it is preferably 10 to 200 μm and more preferably 15 to 100 μm from the viewpoint of excellent flexibility.

In order to improve the adhesiveness, the conductive film may include an undercoat layer containing a polymeric molecule between the resin base material and the copper wire. The undercoat layer is formed, for example, by applying a composition for forming an undercoat layer, containing a polymeric molecule, onto a base material and then carrying out a heating treatment as necessary. Examples of the composition for forming an undercoat layer include an acrylic styrene-based latex containing gelatin, an acrylic resin, a urethane resin, and inorganic or polymeric fine particles.

The conductive film may include a layer other than the undercoat layer, between the resin base material and the copper wire. Examples of the other layer include a refractive index adjusting layer consisting of an organic layer to which particles of a metal oxide such as zirconium oxide, which adjust the refractive index, have been added.

Copper Wire

The conductive film includes a copper wire disposed on a resin base material. The copper wire is composed of a thin copper wire containing copper and is a main member that plays a role in the conductive characteristics of the conductive film.

Examples of the material for forming the thin copper wire that constitutes the copper wire and the peripheral wire that is connected to the copper wire include a copper simple body (metallic copper) and a mixture containing copper and a metal other than copper (a copper alloy), where a copper simple body is preferable. Examples of the metal other than copper contained in the copper alloy include silver, gold, aluminum, nickel, molybdenum, chromium, and palladium.

In addition, the thin copper wire may contain a combination of copper or a copper alloy and a polymeric binder such as gelatin or an acrylic styrene-based latex.

The thickness Ta of the copper wire, that is, the thickness of the thin copper wire that constitutes the copper wire is not particularly limited; however, it is preferably 0.1 to 5.0 μm and more preferably 0.2 to 3.0 μm from the viewpoint that the effect of the present invention and the conductivity of the conductive film are excellent in a well-balanced manner.

The line width Wa of the copper wire, that is, the line width of the thin copper wire that constitutes the copper wire is preferably 10 μm or less and more preferably 5.0 μm or less from the viewpoint that the copper wire is difficult to be visible. The lower limit thereof is not particularly limited; however, it is preferably 0.1 μm or more and more preferably 0.3 μm or more from the viewpoint that the conductivity of the conductive film is more excellent.

Regarding the peripheral wire as well, a configuration similar to that of the above-described thin copper wire can be mentioned as a preferred form.

The thickness Ta and the line width Wa of the copper wire are measured by the following methods.

The surface of the conductive film is observed using a scanning electron microscope (SEM), and one wire of the thin copper wire that extends is selected. A place in one wire of the thin copper wire selected is randomly selected, a cross section orthogonal to the extending direction (see FIG. 2) is formed, and the formed cross section is observed by SEM. Five places are randomly selected in the observation image of the cross section, the length of the thin copper wire in the lamination direction is measured, and the arithmetic average value of the obtained measured values is defined as the thickness Ta of the copper wire. In the same manner, five places are randomly selected in the observation image of the cross section, the length of the thin copper wire in the width direction is measured, and the arithmetic average value of the obtained measured values is defined as the line width Wa of the copper wire.

The copper wire may form a predetermined pattern. That is, the conductive film may have a pattern formed from the copper wire. The pattern thereof is not particularly limited, and it is preferably, for example, a triangle such as a regular triangle, an isosceles triangle, or a right triangle, a quadrangle such as a square, a rectangle, a rhombus, a parallelogram, or a trapezoid, a (regular) n-polygon such as a (regular) hexagon or a (regular) octagon, a circle, an ellipse, a star shape, and a geometric shape that is obtained by combining these geometric shape, and more preferably a mesh shape (a mesh pattern).

FIG. 3 is a plan view illustrating an example of a mesh pattern formed from the copper wire of the conductive film.

As illustrated in FIG. 3, the mesh shape is intended to be a shape including a plurality of opening portions (lattices) 20 constituted of intersecting thin copper wires 14B. In FIG. 3, the opening portion 20 has a rhombus shape (a square shape) in which the length of one side is L; however, the opening portion of the mesh pattern may have another shape, and the shape may be, for example, a polygonal shape (for example, a triangle, a quadrangle, a hexagon, or a random polygonal shape). Further, the shape of the side may be a curved shape other than a straight line or may be a circular arc shape. In the case of the circular arc shape, for example, two sides facing each other may have a circular arc shape protruding outward, and the other two sides facing each other may have a circular arc shape protruding inward. Further, the shape of each of the sides may be a wavy line shape in which a circular arc protruding outward and a circular arc protruding inward are continuous. Needless to say, the shape of each of the sides may be a sine curve.

The length L of one side of the opening portion 20 is not particularly limited, and it is preferably 1,500 μm or less, more preferably 1,300 μm or less, and still more preferably 1,000 μm or less. The lower limit value of the length L is not particularly limited; however, it is preferably 5 μm or more, more preferably 30 μm or more, and still more preferably 80 μm or more. In a case where the length of one side of the opening portion is in the above range, it is possible to further maintain good transparency, and in a case where the conductive film is attached to the front surface of a display device, it is possible to visually recognize the display without an uncomfortable feeling.

From the viewpoint of visible light transmittance, an opening ratio of the mesh pattern that is formed from the copper wire is preferably 90% or more, more preferably 95% or more, and still more preferably 99% or more. The upper limit thereof is not particularly limited; however, it may be less than 100%.

The opening ratio corresponds to an area proportion of a region, excluding a region in which the copper wire is present, to the entire mesh pattern region in a case of being observed in the normal direction of the surface of the conductive film.

Coating Layer

The coating layer is a layer formed to cover the surface of the copper wire, and it contains a metal nanowire and a hydrophobic resin.

Metal Nanowire

The coating layer contains a metal nanowire.

The metal nanowire contained in the coating layer is a wire-shaped conductive substance composed of a metal simple body or an alloy consisting of two or more kinds of metals.

The metal nanowire preferably contains at least one kind of metal selected from the group consisting of copper, silver, gold, aluminum, nickel, and palladium, and it more preferably contains copper from the viewpoint of preventing metal corrosion due to a potential difference. Among the above, the metal that constitutes the metal nanowire is preferably a copper simple body or a copper alloy and more preferably a copper simple body. Examples of the metal other than the copper contained in the copper alloy include the above-described metals other than copper.

The shape of the metal nanowire can be appropriately selected depending on the intended purpose, and examples thereof include shapes such as a cylindrical shape, a rectangular parallelepiped shape, and a columnar shape having a polygonal cross section.

The diameter (fiber diameter) of the metal nanowire is preferably 1 to 500 nm, more preferably 20 to 150 nm, and still more preferably 20 to 75 nm. In a case where the diameter of the metal nanowire is equal to or larger than the above-described lower limit value, the elastic modulus of the coating layer is improved, and cracking or breakage of the coating layer in association with breakage of the copper wire at the time of a bending test is suppressed, whereby the conductive connectivity is maintained, and the effect of the present invention is more excellent. In addition, in a case where the diameter of the metal nanowire is equal to or smaller than the above-described upper limit value, the elastic modulus of the coating layer is in a suitable range, and excessive stretch of the coating layer is suppressed, whereby the performance of preventing disconnection at the time of a bending test to maintain conductive connectivity is more excellent.

The length (fiber length) of the metal nanowire is preferably 1 to 1,000 μm, more preferably 5 to 200 μm, and still more preferably 5 to 100 μm. In a case where the length of the metal nanowire is equal to or smaller than the above-described upper limit value, the generation of aggregates of the metal nanowire, which causes a partial increase in elastic modulus and the excessive stretch of the coating layer, is suppressed in the coating layer, whereby the performance of preventing disconnection at the time of a bending test to maintain conductive connectivity is more excellent. In addition, in a case where the length of the metal nanowire is equal to or larger than the above-described lower limit value, the function of bridging the disconnected part at the time when the copper wire has been disconnected due to a bending test is improved, and the performance of maintaining the conductive connectivity of the copper wire is more excellent.

The ratio (length/diameter) of the length to the diameter of the metal nanowire is preferably 10 to 5,000 and more preferably 30 to 1,500.

The diameter and the length of the metal nanowires are respectively values obtained by randomly selecting 20 wires of the metal nanowire from an observation image including a plurality of metal nanowires, which is obtained by observing the conductive film using a scanning electron microscope (SEM), and arithmetically averaging the lengths of the minor axis and the major axis of each metal nanowire. In a case where a conductive film is manufactured using a commercially available metal nanowire, the diameter and the length of the metal nanowire may be catalog values.

One kind of metal nanowire may be used alone, or two or more kinds thereof may be used in combination.

From the viewpoint that the effect of the present invention is more excellent, the content of the metal nanowire in the coating layer is preferably 3% to 50% by mass, more preferably 10% to 40% by mass, and still more preferably 20% to 30% by mass, with respect to the total mass of the coating layer.

In a case where the content of the metal nanowire is equal to or larger than the above-described lower limit value, the contact area between the metal nanowire and the copper wire is wider, and thus the performance of maintaining the conductive connectivity of the conductive film after a bending test is more excellent. In addition, in a case where the content of the metal nanowire is equal to or smaller than the above-described upper limit value, the elastic modulus of the coating layer is improved, and the coating layer is likely to be suitably stretched, whereby the performance of maintaining the conductive connectivity of the conductive film after a bending test is more excellent.

Hydrophobic Resin

The hydrophobic resin contained in the coating layer in the conductive film according to the embodiment of the present invention means a resin that satisfies the condition that the water contact angle on a surface of a resin film formed on a glass substrate is 60° or more.

In the present specification, the water contact angle refers to a water contact angle measured according to the following method. First, a resin film is formed on a glass substrate using a resin as a measurement target. Using a contact angle meter (for example, FAMMS DM-701, manufactured by Kyowa Interface Science Co., Ltd.), pure water (2 μL of a droplet) is dropwise added onto the surface of the resin film that is kept to be horizontal. The contact angle 20 seconds after the dropwise addition is measured at 10 places, and the arithmetic average value from the measurement results is used as the water contact angle of the resin film. It is noted that the measurement is carried out under the condition of room temperature of 20° C. in accordance with the sessile drop method of Japanese Industrial Standards (JIS) R³257: 1999.

From the viewpoint that the effect of the present invention is more excellent, the water contact angle of the hydrophobic resin, which is measured by the above method, is preferably 75° or more. The upper limit of the water contact angle is not particularly limited; however, it is preferably 100° or less.

The hydrophobic resin is not particularly limited as long as it is a polymeric compound having the above-described water contact angle, and it is possible to use a polyurethane resin, an acrylic resin, a polyvinylidene fluoride resin (PVDF), a vinylidene fluoride-acrylic copolymer, a vinylidene fluoride-hexafluoropropylene copolymer, a polyester resin, a polyamide resin, a polycarbonate resin, a polystyrene resin, a polyvinyl chloride resin, a polyvinylidene chloride resin, a polyvinyl acetate resin, a polyolefin resin, polyethylene glycol (PEG), polyethylene oxide, and polypropylene oxide.

Among them, it is preferable to use a polyurethane resin or an acrylic resin, and it is more preferable to use a polyurethane resin from the viewpoint that the stretchability of the coating layer is more excellent.

The polyurethane resin is, for example, a reaction product between at least one diisocyanate compound represented by Formula (1) and at least one diol compound represented by Formula (2), and it includes a polyurethane resin having a structural unit derived from each of the compounds as a basic skeleton.

OCN—X⁰—NCO (1)

HO—Y⁰—OH (2)

In Formulae (1) and (2), X⁰ and Y⁰ each independently represent a divalent organic residue.

Examples of the diisocyanate compound represented by Formula (1) include a diisocyanate compound in which X⁰ in Formula (1) represents a divalent aliphatic or aromatic hydrocarbon group which may have a substituent (for example, an alkyl group, an aralkyl group, an aryl group, an alkoxy group, or a halogeno group).

As necessary, X may have another functional group that does not react with an isocyanate group, for example, any one of a polymerizable group such as an ethylenic unsaturated group, an ester group, a urethane group, an amide group, or a ureido group.

Examples of the diol compound represented by Formula (2) include a polymeric diol compound such as a polyether diol compound, a polyester diol compound, or a polycarbonate diol compound; a low molecular weight diol compound such as ethylene glycol or neopentyl glycol; a diol compound having an ethylenic unsaturated group; and a diol compound having a carboxylic acid group.

From the viewpoint of the fastness of the coating layer, the polyurethane resin is preferably a polyurethane resin having a reactive group in the side chain, and more preferably a polyurethane resin having a polymerizable group in the side chain.

Examples of the polymerizable group include an ethylenic unsaturated group such as a vinyl group.

In a case where the polyurethane resin has an ethylenic unsaturated group in the side chain, the side chain of the polyurethane resin preferably has at least one functional group selected from the group consisting of an acryloyl group, a methacryloyl group, an acrylamide group, a methacrylamide group, a vinylphenyl group, a vinyl ester group, a vinyl ether group, an allyl ether group, and an allyl ester group, and it is more preferably has an acryloyl group or a methacryloyl group.

Examples of the polyurethane resin having a polymerizable group in the side chain include a polyurethane resin obtained by carrying out copolymerization using at least one selected from the group consisting of a diisocyanate compound containing a polymerizable group (preferably an ethylenic unsaturated group) and a diol compound containing a polymerizable group (preferably an ethylenic unsaturated group).

In other words, the polyurethane resin preferably has at least one structural unit selected from the group consisting of a structural unit derived from a diisocyanate compound containing a polymerizable group (preferably an ethylenic unsaturated group) and a structural unit derived from a diol compound containing a polymerizable group (preferably an ethylenic unsaturated group).

Examples of the diisocyanate compound containing an ethylenic unsaturated group include a diisocyanate compound obtained by an addition reaction between a triisocyanate compound and one equivalent of a monofunctional alcohol or monofunctional amine compound having an ethylenic unsaturated group. Such a diisocyanate compound is described in paragraphs “0033” to “0049” of JP2005-250438A, and this description can be referenced.

Examples of the diol compound containing an ethylenic unsaturated group include trimethylolpropane monoallyl ether and a compound produced by a reaction between a compound such as a halogenated diol compound, a triol compound, or an aminodiol compound, and a compound such as a carboxylic compound, an acid chloride, an isocyanate, an alcohol, an amine, a thiol, or a halogenated an alkyl compound, which contains an ethylenic unsaturated group.

In addition, examples of the diol compound containing an ethylenic unsaturated group include the compounds described in paragraphs “0057” to “0060” of JP2005-250438A, compounds obtained by subjecting tetracarboxylic acid dianhydrides to ring opening with diol compounds, the compounds being described in paragraph “0095” to “0101” of JP2005-250438A, and the compounds described in paragraphs “0064” to “0066” of JP2005-250438A (compounds represented by General Formula (G) described later).

The polyurethane resin having a polymerizable group in the side chain may have at least one structural unit selected from the group consisting of a structural unit derived from a diisocyanate compound having no polymerizable group and a structural unit derived from a diol compound having no polymerizable group.

Examples of the diisocyanate compound having no polymerizable group include an aromatic diisocyanate compound such as 2,4-tolylene diisocyanate, a dimer of 2,4-tolylene diisocyanate, 2,6-tolylene diisocyanate, p-xylylene diisocyanate, m-xylene diisocyanate, 4,4′-diphenylmethane diisocyanate, 1,5-naphthylene diisocyanate, or 3,3′-dimethylbiphenyl-4,4′-diisocyanate; an aliphatic diisocyanate compounds such as hexamethylene diisocyanate, trimethylhexamethylene, lysine diisocyanate, or diisocyanate dimerate; an alicyclic diisocyanate compounds such as isophorone diisocyanate, 4,4′-methylenebis(cyclohexylisocyanate), methylcyclohexane-2,4 (or 2,6) diisocyanate, or 1,3-(isocyanatemethyl)cyclohexane; and a diisocyanate compound which is a reaction product between a diol and a diisocyanate, such as an adduct of 1 mol of 1,3-butylene glycol and 2 mol of tolylene diisocyanate. One kind of these may be used singly, or two or more kinds thereof may be used in combination.

Examples of the diol compound having no polymerizable group include a polyether diol compound, a polyester diol compound, and a polycarbonate diol compound.

The polyurethane resin having a polymerizable group in the side chain is preferably a polyurethane resin having a structural unit represented by General Formula (G-1).

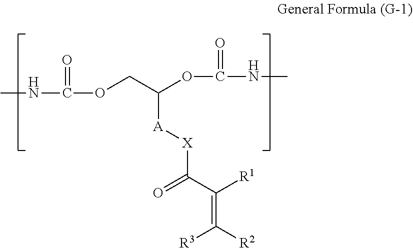

In General Formula (G-1), R¹ to R³ each independently represent a hydrogen atom or a monovalent organic group, A represents a divalent organic residue, and X represents an oxygen atom, a sulfur atom, or —N(R¹²)—, where R¹² represents a hydrogen atom or a monovalent organic group.

Examples of the monovalent organic group as R¹, R², and R³ include an alkyl group which may have a substituent. R¹ is preferably a hydrogen atom or a methyl group. R² and R³ are each preferably a hydrogen atom.

Examples of the divalent organic residue represented by A include a divalent alkylene group which may have a substituent. Examples of the divalent alkylene group include a methylene group, an ethylene group, a propylene group, and a butylene group, where a methylene group is preferable.

X is preferably an oxygen atom.

Examples of the monovalent organic group as R¹² include an alkyl group which may have a substituent, where a methyl group, an ethyl group, or an isopropyl group is preferable.

Examples of the method of synthesizing a polyurethane resin having a structural unit represented by General Formula (G-1) include a method of carrying out a reaction with a diisocyanate compound using a compound represented by General Formula (G) as a diol compound having a polymerizable group.

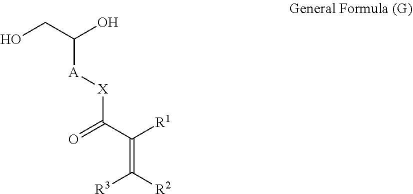

However, in General Formula (G), R¹ to R³, A, and X are respectively the same as R¹ to R³, A, and X in General Formula (G-1).

The polyurethane resin is synthesized by heating the diisocyanate compound and the diol compound in an aprotic solvent to which known catalysts respectively having activities corresponding to the reactivities of the diisocyanate compound and the diol compound are added.

The weight-average molecular weight Mw of the polyurethane resin is preferably 2,000 to 60,000, more preferably 3,000 to 50,000, and still more preferably 3,000 to 30,000.

From the viewpoint of the developability and the controllability of the development speed, the acid value of the polyurethane resin is preferably 20 to 120 mgKOH/g, more preferably 30 to 110 mgKOH/g, and still more preferably 35 to 100 mgKOH/g. The acid value can be measured in accordance with, for example, JIS K0070. However, in a case where a sample is insoluble, dioxane or tetrahydrofuran is used as a solvent.

The hydrophobic resin may be a resin into which a predetermined structure included in the above-described compound is introduced by a compound (hereinafter, also referred to as a “polymerizable compound”) having a reactive group capable of reacting with a polymerizable group contained in the above-described resin.

Hereinafter, the polymerizable compound will be described.

The reactive group contained in the polymerizable compound is not particularly limited as long as it is a reactive group capable of reacting with a polymerizable group contained in the above-described resin; however, it is preferably an ethylenic unsaturated group.

The number of reactive groups contained in the polymerizable compound is not particularly limited. The polymerizable compound may be a monofunctional compound having one reactive group or may be a polyfunctional compound having a plurality of reactive groups.

The molecular weight of the polymerizable compound is preferably 50 to 1,000.

Examples of the polymerizable compound include a monofunctional (meth)acrylate monomer having one ethylenic unsaturated group and a polyfunctional (meth)acrylate monomer having a plurality of ethylenic unsaturated groups, where a polyfunctional (meth)acrylate monomer is preferable.

The number of (meth)acryloyl groups contained in the polyfunctional (meth)acrylate monomer is preferably 2 to 6 and more preferably 2 to 4.

It is preferable that the polyfunctional (meth)acrylate monomer does not have an epoxy group.

Examples of the polyfunctional (meth)acrylate monomer include trimethylolethane triacrylate, trimethylolpropane triacrylate, trimethylolpropane diacrylate, neopentyl glycol di(meth)acrylate, pentaerythritol tetra(meth)acrylate, pentaerythritol (meth)acrylate, dipentaerythritol hexa(meth)acrylate, dipentaerythritol penta(meth)acrylate, hexanediol di(meth)acrylate, dimethyloltricyclodecane di(meth)acrylate, trimethylolpropane tri(acryloyloxypropyl) ether, tri(acryloyloxyethyl)isocyanurate, tri(acryloyloxyethyl)cyanurate, glycerin tri(meth)acrylate; a compound obtained by subjecting ethylene oxide or propylene oxide to an addition reaction with a polyfunctional alcohol such as trimethylolpropane, glycerin, or bisphenol, and then carrying out (meth)acrylation; and urethane acrylate.

Among them, dicyclopentanyldimethanol di(meth)acrylate, trimethylolpropane tri(meth)acrylate, pentaerythritol tetra(meth)acrylate, dipentaerythritol hexa(meth)acrylate, or dipentaerythritol penta(meth)acrylate is preferable.

The polyfunctional (meth)acrylate monomer is preferably a compound having a polycyclic aliphatic group and two or more (meth)acryloyl groups. Examples of the polymerizable compound having a polycyclic aliphatic group and two or more (meth)acryloyl groups include dimethyloltricyclodecane di(meth)acrylate.

Examples of the monofunctional (meth)acrylate include ethyl (meth)acrylate, ethylhexyl (meth)acrylate, 2-(meth)acryloyloxyethyl succinate, and phenoxyethyl (meth)acrylate.

From the viewpoint that the effect of the present invention is more excellent, the hydrophobic resin preferably has a polycyclic aliphatic structure introduced by the polymerizable compound and more preferably has a tricyclodecane structure.

Among the above, it is preferable that the coating layer contains a polyurethane resin having the polycyclic aliphatic structure (more preferably a tricyclodecane structure) described above. Such a polyurethane resin is produced by using, in combination, the above-described polyurethane resin having an ethylenic unsaturated group and a monofunctional or polyfunctional acrylate monomer containing the polycyclic aliphatic structure (preferably a tricyclodecane structure) described above.

One kind of polymerizable compound may be used alone, or two or more kinds thereof may be used in combination.

In a case where the polymerizable compound is used, the content of the polymerizable compound or the structure derived from the polymerizable compound with respect to the total mass of the coating layer is preferably 2% to 50% by mass, more preferably 3% to 40% by mass, and still more preferably 4% to 35% by mass, from the viewpoint that the effect of the present invention is more excellent.

Each structure included in the hydrophobic resin and the content of each structure are can be determined according to a known method such as nuclear magnetic resonance (NMR) spectroscopy, and the content of each structure can also be calculated from the preparation ratio of the monomer used in the production of the hydrophobic resin.

Composition for Forming Coating Layer

The coating layer is preferably a layer that is formed of a composition for forming a coating layer, which contains the metal nanowire and hydrophobic resin described above.

Hereinafter, a composition for forming a coating layer (hereinafter, also referred to as a “composition A”), which contains a metal nanowire and a hydrophobic resin, will be described in more detail.

The composition A contains a metal nanowire and a hydrophobic resin.

In addition to the metal nanowire and the hydrophobic resin, the composition A may contain at least one selected from the group consisting of a polymerizable compound, a polymerization initiator, and an organic solvent.

The metal nanowire, the hydrophobic resin, and the polymerizable compound, which are contained in the composition A, are as described above.

Polymerization Initiator

The composition A may contain a polymerization initiator. The polymerization initiator may be any one of a photopolymerization initiator or a thermal polymerization initiator; however, it is preferably a photopolymerization initiator.

The kind of the photopolymerization initiator is not particularly limited, and a known photopolymerization initiator (a radical photopolymerization initiator or a cationic photopolymerization initiator) can be used.

More specific examples of the photopolymerization initiator include carbonyl compounds such as acetophenone, 2,2-diethoxyacetophenone, p-dimethylacetophenone, p-dimethylaminopropiophenone, benzophenone, 2-chlorobenzophenone, benzyl, benzoin, benzoin methyl ether, benzoin ethyl ether, benzoin isopropyl ether, 2,2-dimethoxy-1,2-diphenylethane-1-one, 1-cyclohexyl phenyl ketone, 1-hydroxy-cyclohexyl-phenyl ketone, 2-hydroxy-2-methyl-1-phenyl-propane-1-one, 1-[4-(2-hydroxyethoxy)-phenyl]-2-hydroxy-2-methyl-1-propane-1-one, oligo(2-hydroxy-2-methyl-1-one-(4-(1-methylvinyl)phenyl)propanone), 2-hydroxy-1-{4-[4-(2-hydroxy-2-methyl-propionyl)-benzyl]-phenyl}-2-methyl-propane-1-one, 2-methyl-1-[4-(methylthio)phenyl]-2-morpholinopropane-1-one, 2-benzyl-2-dimethyl amino-1-(4-morpholinophenyl)-butanone-1, bis(2,4,6-trimethylbenzoyl)-phenylphosphine oxide, 2,4,6-trimethylbenzoyl-diphenyl-phosphine oxide, bis(2,6-dimethoxybenzoyl)-2,4,4-trimethyl-pentylphosphine oxide, ethyl-(2,4,6-trimethylbenzoyl)phenylphosphinate, 1,2-octanedione, 1-[4-(phenylthio)-2-(O-benzoyloxime)], methylbenzoyl formate, 4-methylbenzophenone, 4-phenylbenzophenone, 2,4,6-trimethylbenzophenone, 4-benzoyl-4′-methyldiphenyl sulfide, and 1-[4-(4-benzoylphenylsulfonyl)phenyl)]-2-methyl-2-(4-methylphenylsulfonyl)propane-1-one, and; sulfur compounds such as thioxanthone, 2-chlorothioxanthone, 2-methylthioxanthone, and tetramethylthiuram disulfide.

One kind of polymerization initiator may be used alone, or two or more kinds thereof may be used in combination.

In a case where the composition A contains a polymerization initiator, the content thereof is not particularly limited; however, it is preferably 0.1% to 10% by mass with respect to the total mass of the composition A from the viewpoint of the curing properties of the coating layer.

Organic Solvent

The composition A may contain an organic solvent, and it preferably contains an organic solvent from the viewpoint of handleability.

Examples of the organic solvent include alcohols such as methanol, ethanol, n-propanol, isopropanol, n-butanol, sec-butanol, and n-hexanol; ketones such as acetone, ethyl methyl ketone, methyl isobutyl ketone, cyclohexanone, and diisobutyl ketone; ester compounds such as ethyl acetate, butyl acetate, n-amyl acetate, methyl acetate, ethyl propionate, dimethyl phthalate, ethyl benzoate, and methoxypropyl acetate; aromatic hydrocarbons such as toluene, xylene, benzene, and ethylbenzene; halogenated hydrocarbons such as carbon tetrachloride, trichloroethylene, chloroform, 1,1,1-trichloroethane, methylene chloride, and monochlorobenzene; aliphatic hydrocarbons such as octane and decane; ethers such as tetrahydrofuran, diethyl ether, ethylene glycol monomethyl ether, ethylene glycol monoethyl ether, and 1-methoxy-2-propanol; petroleum-based solvents such as petroleum ether, petroleum naphtha, hydrogenated petroleum naphtha, and solvent naphtha; dimethylformamide; dimethylacetamide; dimethylsulfoxide; and sulfolane.

One kind of organic solvent may be used alone, or two or more kinds thereof may be used in combination.

The content of the organic solvent is preferably 10% to 90% by mass, more preferably 20% to 80% by mass, still more preferably 30% to 70% by mass, with respect to the total mass of the composition A from the view that the manufacturing suitability of the coating film is more excellent.

Additive

The composition A may contain an additive other than the above-described components.

Examples of the additive include a sensitizing agent, a thermal crosslinking agent, a curing agent (thermal curing accelerator), an adhesion accelerator, a coating aid, a surface lubricant, an antioxidant, a corrosion inhibitor, a light stabilizer, an ultraviolet absorbing agent, a polymerization inhibitor, a silane coupling agent, and a filler.

In a case where the composition A contains a photopolymerization initiator, it is preferable that the composition A further contains a sensitizing agent.

The sensitizing agent is not particularly limited and may be appropriately selected depending on the use appropriately and irradiation light. Examples thereof include the compounds described in paragraph of JP2007-002030A.

One kind of sensitizing agent may be used alone, or two or more kinds thereof may be used.

The content of the sensitizing agent is preferably 0.05% to 30% by mass, more preferably 0.1% to 20% by mass, and still more preferably 0.2% to 10% by mass, with respect to the solid content of the composition A.

Examples of the thermal crosslinking agent include a compound having a cyclic ether group (an oxylane group, oxetanyl group, or the like), a compound having a blocked isocyanate group, a compound having an oxazolyl group, and a compound having an ethylene carbonate group, where a compound having an oxylane group is preferable.

One kind of thermal crosslinking agent may be used alone, or two or more kinds thereof may be used in combination.

The content of the thermal crosslinking agent is preferably 1% to 50% by mass, more preferably 2% to 40% by mass, and still more preferably 3% to 30% by mass, with respect to the solid content of the composition A.

For details of the other additives, for example, paragraphs 0032 to 0034 of JP2012-229412A can be referenced. The content of the additive contained in the composition A can be appropriately adjusted and is not particularly limited as long as the effect of the present invention is not impaired.

Configuration of Coating Layer

The characteristics of the coating layer will be described in detail with reference to a schematic cross-sectional view of the conductive film 10 illustrated in FIG. 2.

In FIG. 2, the coating layer 16 is disposed to cover the surface of the thin copper wire 14a disposed on the resin base material 12. Specifically, an apex surface 14t, which is the surface of the thin copper wire 14a on a side opposite to a surface facing the resin base material 12, and a side surface 14s, which includes a side surface of the thin copper wire 14a in the extending direction and is the surface intersecting the surface facing the resin base material 12 and the apex surface 14t, are covered by the coating layer 16.

Hereinafter, in the coating layer 16, a region disposed to cover the apex surface 14t of the thin copper wire 14a is also referred to as an apex surface part 16t, and a region disposed to cover the side surface 14s of the thin copper wire 14a is also referred to as a side surface part 16s.

Here, the coating layer included in the conductive film may cover only a part of the surface of the copper wire. That is, the thin copper wire may have a region in which a part of the apex surface and the side surface is not covered by the coating layer. It is presumed that as long as the coating layer covers a part of the surface of the copper wire, the function of maintaining the conductive connectivity after a bending test is exhibited in the region covered by this coating layer.

From the viewpoint that the effect of the present invention is more excellent, it is preferable that the coating layer included in the conductive film covers substantially the entire surface (the apex surface and the side surface) of the copper wire except for a portion that is electrically connected to other conductive members, and the copper wire is not exposed.

The thickness of the coating layer 16 that covers the copper wire 14 is not particularly limited, and it is appropriately selected depending on the use application.

In the coating layer 16, the thickness Tt of the apex surface part 16t disposed on the apex surface 14t of the thin copper wire 14a is preferably 0.5 to 10 μm, more preferably 1 to 10 μm, and still more preferably 1 to 5 μm.

In a case where the thickness Tt is equal to or larger than the above-described lower limit value, the adhesiveness between the apex surface part of the coating layer and the copper wire is improved, and the peeling of the coating layer from the copper wire is suppressed even after a bending test has been carried out, whereby the performance of maintaining conductive connectivity is more excellent. In addition, in a case where the thickness Tt is equal to or smaller than the above-described upper limit value, the excessive stretch on the surface of the apex surface part opposite to the copper wire at the time when a bending test has been carried out is suppressed, and the occurrence of cracking in the coating layer is suppressed, whereby the performance of maintaining conductive connectivity is more excellent.

In the coating layer 16, the thickness Ts of the side surface part 16s disposed on the side surface 14s of the thin copper wire 14a is preferably 0.5 to 10 μm, more preferably 1 to 10 μm, and still more preferably 1 to 5 μm. It is noted that as illustrated in FIG. 2, the thickness Ts of the side surface part 16s means the total length of the region occupied by the side surface part 16s in the width direction.

In a case where the thickness Ts is equal to or larger than the above-described lower limit value, the formation of the coating layer that covers the apex surface part of the thin copper wire is facilitated, and as a result, the performance of maintaining conductive connectivity by the coating layer is more excellent. In addition, in a case where the thickness Ts is equal to or smaller than the above-described upper limit value, the distance between the thin copper wires is increased, and the insulating properties between the thin copper wires can be improved.

The thickness Tt of the apex surface part and the thickness Ts of the side surface part of the coating layer are measured according to the measuring method for the thickness Ta and the line width Wa of the copper wire using a scanning electron microscope (SEM).

For example, regarding the thickness Tt of the apex surface part of the coating layer, five places in the apex surface part of the coating layer are randomly selected from an observation image of the cross section (see FIG. 2) of the conductive film along the direction orthogonal to the extending direction, the observation image being obtained according to the above-described measuring method, the thickness in the lamination direction is measured, and the arithmetic average value of the obtained measured values is defined as the thickness Tt of the apex surface part of the coating layer. In the same manner, five places in the side surface part of the coating layer are randomly selected from the observation image of the cross section, the thicknesses in the width direction are measured, and the arithmetic average value of the obtained measured values is defined as the thickness Ts of the side surface part of the coating layer.

In a case where the copper wire forms a predetermined pattern, the same pattern as the predetermined pattern is formed by the coating layer that covers the copper wire. That is, the conductive film may have a pattern formed from the copper wire and the coating layer. The pattern formed from the copper wire and the coating layer is as described above, including the preferred aspect thereof

Other Members

The conductive film may have other members in addition to the resin base material, the copper wire, and the coating layer.

Examples of the other members which may be included in the conductive film include the undercoat layer described above and a non-conductive portion that is disposed between a plurality of thin copper wires that form a pattern in a case where the copper wire has a pattern.

The non-conductive portion is a region that does not exhibit conductivity and substantially does not contain a conductive metal. Here, “substantially does not contain” means that the metal content in the non-conductive portion is 0.1% by mass or less with respect to the total mass of the non-conductive portion.

The non-conductive portion preferably contains a polymeric compound as a main component.

Examples of the polymeric compound contained in the non-conductive portion include a hydrophobic resin that is contained in the coating layer. In addition, the non-conductive portion may contain a polymeric compound other than the hydrophobic resin.

The description that the non-conductive portion contains a polymeric compound “as a main component” means that the content of the polymeric compound is 50% by mass or more with respect to the total mass of the non-conductive portion. The content of the polymeric compound in the non-conductive portion is preferably 90% by mass or more and more preferably 95% by mass or more. The upper limit value thereof is not particularly limited and may be 100% by mass.

Manufacturing Method for Conductive Film

The conductive film can be manufactured by, for example, a method including a step 1 of forming a copper wire on a resin base material and a step 2 of forming a coating layer on the copper wire (hereinafter, also referred to as the “present manufacturing method”).

Step 1

Examples of the method of forming a copper wire on a resin base material include a method having a step of forming a copper foil layer on a resin base material and a step of forming a patterned copper wire from the formed copper foil layer according to a photolithography method.

Examples of the method of forming a copper foil layer include known methods. Examples thereof include methods using a wet process, such as an application method, an inkjet method, a coating method, and a dipping method, and methods using a dry process, such as a vapor deposition method (resistive heating, an EB method, or the like), a sputtering method, and a CVD method. Among the film forming methods described above, a sputtering method is preferably applied.

In a case of subjecting the copper foil layer to etching processing according to a photolithography method, it is possible to form a copper wire which is formed of a thin copper wire and has a desired pattern, a peripheral wire, and the like.

The photolithography method is a method of processing a copper foil layer into a desired pattern, for example, by subjecting the copper foil layer to each of steps of resist coating, exposure, development, rinsing, etching, and resist peeling.

A known photolithography method can be appropriately used for the formation of the copper wire. For example, any one of a positive-tone resist or a negative-tone resist can be used as a resist. In addition, after the resist is applied, preheating or prebaking can be carried out as necessary. At the time of exposure, a pattern mask having a desired pattern may be disposed, and light (for example, ultraviolet rays) having a wavelength suitable for the resist used may be irradiated through the pattern mask. After the exposure, development can be carried out with a developer suitable for the resist used. After the development, the development is stopped with a rinsing liquid such as water, and concurrently washing is carried out, whereby a resist pattern is formed.

Next, the formed resist pattern can be subjected to pretreatment or post-baking, as necessary, and then engraved with etching. As an etchant, a known copper etchant such as an aqueous solution of iron (III) chloride can be used, for example, in a case where the copper foil layer contains copper,

After etching, the residual resist is peeled off to obtain a copper wire having a desired pattern. As described above, the photolithography method applied to the present manufacturing method is a method generally recognized by those skilled in the art, and thus a specific application aspect thereof can be easily selected by those skilled in the art according to an intended purpose.

Step 2

The present manufacturing method includes a step 2 of forming a coating layer that covers a copper wire, on the copper wire formed in the step 1.

A method for forming a coating layer is not particularly limited as long as the coating layer can be formed on the copper wire with high accuracy, and examples thereof include a method using a transfer film, a photolithography method, and a printing method such as screen printing. In addition, it is preferable that the coating layer is formed on a copper wire by using the above-described composition for forming a coating layer (the composition A).

The method of forming a coating layer using the composition A is not particularly limited, and examples thereof include a method (a transfer method) of forming a coating layer on a copper wire by using a transfer film and a method (a coating method) of forming a coating film of the composition A on a copper wire and carrying out treatments such as drying and exposure of the coating film, as necessary, to form a coating layer.

Among the above, the method of forming a coating layer is preferably a method of forming a coating layer on a copper wire by using a transfer film.

Formation of Coating Layer by Transfer Method

Examples of the method of forming a coating layer by a transfer method include a method having a step of producing a transfer film having a photosensitive layer consisting of a temporary support and the composition A (hereinafter, also referred to as a “transfer film preparation the step”), a step of bonding the above-described transfer film and the copper wire-attached resin base material produced in the step 1 to each other so that the photosensitive layer and the copper wire are in contact with each other (hereinafter, also referred to as a “transfer step”), a step of subjecting the photosensitive layer to pattern exposure (hereinafter, also referred to as “exposure step”), a step of peeling the temporary support from the laminate (hereinafter, also referred to as “peeling step”), and a step of removing a part of the photosensitive layer to form a patterned coating layer (hereinafter, also referred to as a “development step”).

By the above-described manufacturing method, a conductive film having a resin base material, a copper wire, and a coating layer is manufactured.

Hereinafter, each step will be described.

Transfer Film Preparation the Step

Examples of the transfer film preparation the step include a method of forming a photosensitive layer consisting of the above-described composition for forming a coating layer (the composition A) on the surface of a temporary support. More specifically, the photosensitive layer is formed by applying the composition A to the surface of a temporary support and then drying the coating film of the composition A.

Examples of the temporary support include a glass substrate and a resin film, where a resin film is preferable, and a resin film having heat resistance and solvent resistance is more preferable. In addition, the temporary support is preferably a film that has flexibility and does not undergo significant deformation, contraction, or elongation under pressure, or under pressure and heating.

Examples of such a resin film include a polyethylene terephthalate (PET) film, a polyethylene film, a polypropylene film, and a polycarbonate film. Among them, a polyethylene terephthalate film is preferable from the viewpoint of transparency and heat resistance.

The surface of the resin film described above may be subjected to a mold release treatment so that the resin film can be easily peeled off from the photosensitive layer later.

In order to impart handleability, it is preferable that a layer having particles is present on the resin film described above.

The thickness of the temporary support is preferably 5 to 300 μm, more preferably 10 to 200 μm, and still more preferably 15 to 100 μm.

In a case where the thickness of the temporary support is equal to or larger than the above-described lower limit value, mechanical strength is improved, and breaking of the temporary support is suppressed in the step of applying the composition A to form a photosensitive layer, the exposure step, and the step of peeling the temporary support from the transfer film after the transfer.

In addition, in a case where the thickness of the temporary support is equal to or smaller than the above-described upper limit value, the resolution in a case where the photosensitive layer is irradiated with an actinic ray through the temporary support is improved.

It is noted that the thickness of each layer included in the transfer film is a value obtained by measuring a cross section including a direction perpendicular to the main surface of the layer is observed using SEM, measuring the thickness of the layer at 10 or more points based on the obtained observation image, and calculating the average value thereof.

From the viewpoint of the exposure sensitivity of the photosensitive layer and the resolution of the conductive pattern, the haze value of the temporary support is preferably 0.01% to 5.0% and more preferably 0.01% to 3.0%.

The haze value can be measured according to a method in accordance with JIS K 7105 (Optical Characteristic Test Method for Plastics) by using, for example, a commercially available turbidity meter such as NDH-1001DP (product name, manufactured by NIPPON DENSHOKU INDUSTRIES Co., Ltd.).

In the temporary support, the light transmittance of the wavelength (more preferably, a wavelength of 365 nm) of the actinic ray to be applied is preferably 50% or more, more preferably 60% or more, and still more preferably 70% or more, from the viewpoint of the exposure sensitivity and the resolution of the photosensitive layer.

The light transmittance of the layer included in the transfer film is a rate of the intensity of the emitted light that has emitted and passed through a layer with respect to the intensity of the incident light in a case where the light is incident in a direction perpendicular to the main surface of the layer (the thickness direction), and it is measured by using, for example, MCPD Series manufactured by Otsuka Electronics Co., Ltd.

In addition, it is preferable that the resin film to be used as the temporary support does not have deformation such as wrinkles and scratches and the like.

From the viewpoint of pattern forming properties during pattern exposure through the temporary support and transparency of the temporary support, it is preferable that the numbers of fine particles, foreign substances, and defects, which are included in the temporary support, are small. The number of fine particles, foreign substances, and defects having a diameter of 1 μm or more is preferably 50 pieces/10 mm² or less, more preferably 10 pieces/10 mm² or less, and still more preferably 3 pieces/10 mm² or less.

Examples of the method of forming a photosensitive layer include a method of preparing the above-described composition A, applying the composition A to the surface of a temporary support, and then drying the coating film of the composition A to form a photosensitive layer.

The composition A is as described above, including the preferred aspect thereof.

It is noted that the photosensitive layer is preferably a negative-tone photosensitive layer in which the solubility of the exposed portion in a developer is reduced by the exposure step described later and the non-exposed portion is removed by the development. However, the photosensitive layer is not limited to the negative-tone photosensitive layer, and it may be a positive-tone photosensitive layer in which the solubility of the exposed portion in a developer is improved by the exposure and the exposed portion is removed by the development.

Examples of the coating method for the composition A include known methods such as a roll coating method, a comma coating method, a gravure coating method, an air knife coating method, a die coating method, a bar coating method, and a spray coating method, which are not limited to these.

In addition, the method of drying the coating film of the composition A is not particularly limited, and examples thereof include a method of applying hot air having a temperature of 70° C. to 150° C. to the coating film for 5 to 60 minutes by using a hot air circulation type dryer.

In a case where the photosensitive layer is formed using the composition A containing an organic solvent, the content of the organic solvent after drying in the photosensitive layer is preferably 2% by mass or less with respect to the total mass of the photosensitive layer in order to prevent the organic solvent from diffusing in a subsequent step.

By the above-described method, a transfer film having a temporary support and a photosensitive layer consisting of the composition A can be obtained.

The transfer film may have a layer other than the temporary support and the photosensitive layer. Examples of the other layer contain a protective film.

The transfer film preferably has a protective film that comes into contact with a surface that does not face the temporary support.

A resin film having heat resistance and solvent resistance can be used as the protective film, and examples thereof include a polyethylene terephthalate film, a polypropylene film, and a polyolefin film such as a polyethylene film. In addition, a resin film composed of the same material as the temporary support may be used as the protective film.

Among them, a polyolefin film is preferable, and a polypropylene film or a polyethylene film is more preferable.

The thickness of the protective film is preferably 1 to 100 μm and more preferably 5 to 50 μm. The thickness of the protective film is preferably 1 μm or more from the viewpoint of excellent mechanical strength, and it is preferably 100 μm or less from the viewpoint of relatively low cost.

The adhesive force between the protective film and the photosensitive layer is preferably smaller than the adhesive force between the temporary support and the photosensitive layer in order to facilitate the peeling of the protective film from the photosensitive layer.

The method of manufacturing a transfer film having a protective film is not particularly limited, and it is possible to manufacture the transfer film, for example, by bonding a resin film to the surface of the photosensitive layer of the transfer film manufactured by the above method.

Transfer Step

In the transfer step, the transfer film manufactured in the transfer film preparation the step and the copper wire-attached resin base material produced in the step 1 are bonded to each other to produce a laminate. At this time, the surface of the transfer film on the side opposite to the temporary support (that is, the surface of the photosensitive layer) and the copper wire are in contact with each other.

It is noted that in a case where the transfer film has a protective film, the protective film is peeled off from the transfer film, and then the temporary support and the photosensitive layer are transferred to the copper wire-attached resin base material.

In the transfer step, it is preferable that the copper wire-attached resin base material is pressure-bonded on the side of the photosensitive layer of the transfer film while heating the photosensitive layer and/or the copper wire-attached resin base material. In this case, neither the heating temperature nor the pressure-bonding pressure is particularly limited; however, the heating temperature is preferably 70° C. to 130° C., and the pressure-bonding pressure is preferably about 0.1 to 1.0 MPa (about 1 to 10 kgf/cm²). In addition, from the viewpoint of adhesiveness and followability, it is preferable to carry out the operation under reduced pressure.

In addition, instead of the heating treatment of the photosensitive layer and/or the copper wire-attached resin base material in the transfer step, the preheating treatment of the copper wire-attached resin base material may be carried out before the transfer step in order to further improve the adhesiveness.

Exposure Step

In the exposure step, after the transfer step described above, the photosensitive layer is subjected to pattern exposure.

In the exposure step, a part of the photosensitive layer is exposed by applying an actinic ray in an imagewise manner through a negative-tone or positive-tone mask pattern, which is called artwork.

In a case where the photosensitive layer is a negative-tone photosensitive layer, the photosensitive layer is cured in a region (exposed portion) irradiated with the actinic ray, whereby a cured film is formed. On the other hand, in a region (non-exposed portion) not irradiated with the actinic ray, the photosensitive layer is not cured.

Examples of the light source of the actinic ray in the exposure step include a known light source.

The light source is not particularly limited as long as it is a light source that effectively emits light having a wavelength (for example, 365 nm or 405 nm) that makes it possible to expose the photosensitive layer, and examples thereof include a carbon arc lamp, a mercury vapor arc lamp, an ultrahigh pressure mercury lamp, a high pressure mercury lamp, and a xenon lamp.

In addition, as the light source, an Ar ion laser or a semiconductor laser may be used, or a photographic floodlight bulb or a solar lamp may be used.

Further, a method of applying an actinic ray in an imagewise manner, without using a mask pattern, by a direct drawing method using a laser exposure method or the like may be adopted.

The exposure amount in the exposure step varies depending on the device to be used and the composition of the photosensitive layer; however, it is preferably 5 to 1,000 mJ/cm² and more preferably 10 to 700 mJ/cm². It is preferably 10 mJ/cm² or more from the viewpoint of excellent photocuring properties, and it is preferably 1,000 mJ/cm² or less from the viewpoint of resolution.

The exposure atmosphere in the exposure step is not particularly limited, and the exposure can be carried out in the air, in nitrogen, or in a vacuum.

Peeling Step

In the present manufacturing method, the peeling step of peeling the temporary support from the laminate is carried out. The peeling method is not particularly limited, and a known method can be appropriately adopted.

The peeling step may be carried out before the exposure step or may be carried out after the exposure step.

In order to prevent the contamination due to contact between the coating layer and the mask pattern and to avoid the influence of foreign substances that have adhered to a mask pattern on the exposure, it is preferable to carry out pattern exposure through a temporary support. In other words, in the formation of the coating layer, it is preferable to carry out the peeling step after the exposure step.

Development Step

The development step is a step of removing a non-exposed portion of the photosensitive layer. In a case of carrying out the development step, a patterned coating layer is formed.

Specifically, a developer is brought into contact with the exposed surface of the photosensitive layer (coating layer) exposed by peeling off the temporary support, thereby removing an uncured portion (non-exposed portion) of the photosensitive layer. As a result, a patterned coating layer is formed.

Examples of the developer include an alkaline aqueous solution, an aqueous developer, and an organic solvent-based developer. The development treatment in the development step is carried out by a known method such as spraying, swinging immersion, brushing, or scraping by using, for example, these developers.

The developer is preferably an alkaline aqueous solution since it is safe, is stable, and has good operability. The alkaline aqueous solution is preferably an aqueous solution of 0.1% to 5% by mass of sodium carbonate, an aqueous solution of 0.1% to 5% by mass of potassium carbonate, an aqueous solution of 0.1% to 5% by mass of sodium hydroxide aqueous, or an aqueous solution of 0.1% to 5% by mass of sodium tetraborate.

The pH of the alkaline aqueous solution that is used as the developer is preferably in a range of 9 to 11. The temperature of the developer is adjusted according to the developability of the photosensitive layer. In addition, the alkaline aqueous solution may contain a surfactant, an antifoaming agent, a small amount of an organic solvent for accelerating development, or the like.

An aqueous developer consisting of water or an alkaline aqueous solution and one or more organic solvents may be used as the developer. Here, examples of the base contained in the alkaline aqueous solution include, in addition to the sodium carbonate, potassium carbonate, sodium hydroxide, and sodium tetraborate described above, borax, sodium metasilicate, tetramethylammonium hydroxide, ethanolamine, ethylenediamine, diethylenetriamine, 2-amino-2-hydroxymethyl-1,3-propanediol, 1,3-diamino-2-propanol, and morpholine.

Examples of the organic solvent include methyl ethyl ketone, acetone, ethyl acetate, alkoxy ethanol having an alkoxy group having 1 to 4 carbon atoms, ethyl alcohol, isopropyl alcohol, butyl alcohol, diethylene glycol monomethyl ether, diethylene glycol monoethyl ether, and diethylene glycol monobutyl ether. These may be used alone or in a combination of two or more kinds thereof.

The content of the organic solvent in the aqueous developer is preferably 2% to 90% by mass with respect to the total mass of the aqueous developer. The temperature of the aqueous developer is adjusted according to the developability of the photosensitive layer. The pH of the aqueous developer is not particularly limited as long as the development of the photosensitive layer is possible; however, it is more preferably 8 to 12 and still more preferably 9 to 10.

In addition, the aqueous developer may contain a small amount of additives such as a surfactant and an antifoaming agent.

Examples of the organic solvent-based developer include 1,1,1-trichloroethane, N-methylpyrrolidone, N,N-dimethylformamide, cyclohexanone, methyl isobutyl ketone, and γ-butyrolactone. The organic solvent-based developer preferably contains water in a range of 1% to 20% by mass in order to prevent ignition.

Two or more kinds of the above-described developers may be used in combination, as necessary.

Examples of the developing method include a dipping method, a puddling method, a spraying method, brushing, and slapping. Among these, it is preferable to use a high-pressure spraying method from the viewpoint of improving the resolution.

The laminate after the development is preferably subjected to an etching treatment in which metal nanowires remaining in the region from which the non-exposed portion has been removed and metal nanowires protruding from the exposed portion of the photosensitive layer are dissolved to be removed by using an etchant. By the etching treatment, it is possible to prevent the short-circuit between the thin copper wires included in the conductive film and improve the insulating properties between the thin copper wires.

Examples of the etchant that is used in the etching treatment include the etchant used in the step 1, including the preferred aspect thereof.

In addition, the method of applying the etchant in the etching treatment is the same as the development method with the developer.

After the development, the coating layer may be further cured by heating at 60° C. to 250° C. or exposure at an exposure amount of 0.2 to 10 J/cm², as necessary.

Formation of Coating Layer by Coating Method

A description will be made for a method of forming a coating layer of a step 2 according to a coating method of forming a coating film of the composition A on a copper wire and carrying out treatments such as drying, exposure, and development of the coating film as necessary.

The method of forming a coating film of the composition A on a copper wire is not particularly limited and may be the same as the method of forming a photosensitive layer on a temporary support in the transfer method.

The conditions for the drying treatment for drying the coating film of the composition A on the copper wire are not particularly limited, and the drying treatment is preferably carried out at 25° C. to 220° C. (preferably 70° C. to 150° C.) for 1 to 60 minutes by using, for example, a hot air circulation type dryer.

Both the exposure treatment for subjecting a photosensitive film consisting of the composition A to pattern exposure and the development treatment for developing the photosensitive layer which has been subjected to the pattern exposure can be carried out according to the methods described in the exposure step and the development step in the transfer method.

Use Application of Conductive Film

The conductive film can be applied to various use applications, and for example, it can be applied to the manufacture of a touch panel (or a touch panel sensor), a semiconductor chip, various electrical wiring plates, flexible printed circuits (FPC), a chip on film (COF), tape automated bonding (TAB), an antenna, a multilayer interconnection board, a motherboard, and the like. Among these, the present conductive film is preferably used in the manufacture of a touch panel (a capacitance-type touch panel).

In the touch panel having the present conductive film, the copper wire can effectively function as a detection electrode. In a case where the present conductive film is used in a touch panel, examples of the display panel that is used in combination with the conductive film include a liquid crystal panel and an organic light emitting diode (OLED) panel, where the conductive film is preferably used in combination with an OLED panel.

In addition to the copper wire, the conductive film may further have a conductive portion having a configuration different from that of the copper wire. This conductive portion may be electrically connected to the above-described copper wire to be conductively connected. Examples of the conductive portion include a peripheral wire having a function of applying a voltage to the above-described copper wire and an alignment mark for adjusting the position of a member to be laminated with that of the conductive film.

Examples of the use application of the conductive film other than those described above include an electromagnetic wave shield that blocks electromagnetic waves such as radio waves and microwaves (ultra-high frequency radio waves), generated from electronic apparatuses such as a personal computer and a workstation and prevents static electricity. Such an electromagnetic wave shield can be used not only for the main body of the personal computer but also for an electronic apparatus such as a videographing apparatus or an electronic medical apparatus.

The conductive film can also be used for a transparent exothermic body.

The conductive film may be used in the form of a laminate having a conductive film and other members such as a pressure-sensitive adhesive sheet and a peeling sheet during handling and transportation. The peeling sheet functions as a protective sheet for preventing the occurrence of scratching on the conductive member during transportation of the laminate.

Further, the conductive film may be handled in the form of a composite body having, for example, a conductive film, a pressure-sensitive adhesive sheet, and a protective layer in this order.

### EXAMPLES

Hereinafter, the present invention will be described in more detail based on Examples below. In Examples below, the material, the using amount, the proportion, the details of treatment, the treatment procedure can be suitably modified without departing from the gist of the present invention, and thus the scope of the present invention should not be construed as being limited by Examples below.

### Example 1

Production of Copper Wire-Attached Resin Base Material (Step 1)

As a resin base material, a polyethylene terephthalate (PET) film (manufactured by TOYOBO Co., Ltd., COSMOSHINE (registered trade name) A4300) having a thickness of 50 in which easy adhesion layers were formed on both surfaces, was prepared.

Using copper as a target, one surface of this resin base material was subjected to sputtering film formation, while introducing argon gas (flow rate: 270 sccm) into a sputtering apparatus, under the conditions of a film forming chamber pressure of 0.4 Pa, a power density of 4.2 W/cm², and a roll temperature during film formation of 90° C., whereby a copper film was formed. The thickness of the copper film was 500 nm.

After forming the copper film, a rust prevention treatment was carried out on the copper film, and the copper film was patterned by a photolithography method. More specifically, a positive-tone resist was applied onto the copper film to form a resist film having a thickness of 2 μm. Next, the resist film was irradiated with a metal halide lamp in a state where a glass photo mask was disposed on the resist film, and then the laminate on which the resist film was disposed was immersed in an aqueous sodium hydroxide solution having a concentration of 3% to carry out development, whereby a resist film having a comb-shaped pattern was obtained.

With this resist film as a mask, the copper film was etched using an aqueous solution of iron (III) chloride having a concentration of 5% to form a comb-shaped pattern in which the line width is 10 μm, the space width is 20 μm, and thirty lines (thin copper wires) are provided. Finally, the remaining resist film was peeled off to obtain a resin base material having a comb-shaped patterned copper wire composed of thin copper wires having a thickness of 500 nm.

Formation of coating layer (step 2)

### Synthesis Example 1: Synthesis of Ethylenic Unsaturated Group-Containing Urethane Resin

In a 500 mL three-necked round-bottomed flask equipped with a condenser and a stirrer, 10.86 g (0.081 mol) of 2,2-bis(hydroxymethyl)propionic acid (DMPA) and 16.82 g (0.105 mol) of glycerol monomethacrylate (GLM) were dissolved in 79 mL of propylene glycol monomethyl ether monoacetate. To this, 37.54 g (0.15 mol) of 4,4-diphenylmethane diisocyanate (MDI), 0.1 g of 2,6-di-t-butylhydroxytoluene, and 0.2 g of Neostan U-600 (product name, Nitto Kasei Co., Ltd.) as a catalyst were added, and the resultant mixture was heated and stirred at 75° C. for hours. Thereafter, the reaction solution was diluted with methyl alcohol, and then stirring was carried out for 30 minutes to obtain an ethylenic unsaturated group-containing urethane resin solution (a resin solution 1) having a concentration of solid contents of 40% by mass.

The ethylenic unsaturated group-containing urethane resin (resin 1) obtained as above had a solid content acid value of 70 mgKOH/g, a weight-average molecular weight Mw of 8,000, and an ethylenic unsaturated group equivalent of 1.5 mmol/g.

In addition, using a contact angle meter (“FAMMS DM-701” manufactured by Kyowa Interface Science Co., Ltd.), the water contact angle of a film consisting of the resin 1, where the film being formed on the glass substrate, was measured according to the above-described method. As a result, the water contact angle of the film consisting of the resin 1 was 84°.

Preparation of Composition for Forming Coating Layer

The following components were mixed according to the amounts shown in Example 1 of Table 1, and the resultant mixture was dispersed with a bead mill (Eiger Mill M-50, manufactured by Eiger Japan, Co., Ltd., media; zirconia beads having a diameter of 1 mm, filling ratio: 75% by volume) for 1.5 hours to prepare a composition for forming a coating layer.

Metal Nanowire
Copper nanowire (“A1” manufactured by Novarials Corporation, diameter: 100 nm, length: 50 to 200 μm)

Hydrophobic Resin
Resin solution 1 containing the resin 1 obtained in Synthesis Example 1 (concentration of solid contents: 40% by mass)

Polymerizable Compound
A-DCP (dimethyloltricyclodecane diacrylate, manufactured by Kyoeisha Chemical Co., Ltd.)

Photopolymerization Initiator
Omnirad (registered trade name) 907 (acetophenone-based, manufactured by IGM Resins RV)

Additive
Curing agent: Melamine (manufactured by Fujifilm Wako Pure Chemical Corporation)
Thermal crosslinking agent: Epotohto YDF-170 (manufactured by Tohto Kasei Co., Ltd.)
Sensitizing agent: DETX-S (manufactured by Nippon Kayaku Co., Ltd.)
Coating aid: MEGAFACE (registered trade name) F-780F (manufactured by DIC Corporation: a 30% by mass methyl ethyl ketone solution)

Solvent
Cyclohexanone (manufactured by Fujifilm Wako Pure Chemical Corporation) Preparation of photosensitive layer-attached transfer film

As a temporary support, a PET film having a thickness of 50 μm was prepared.

The composition for forming a coating layer was applied onto a temporary support using a bar coater so that the thickness of the photosensitive layer after drying was 1.2 The obtained coating film was dried in a hot air circulation type dryer at 80° C. for 30 minutes to form a photosensitive layer.

Next, a polypropylene (PP) film having a thickness of 35 μm was prepared, and the PP film was bonded to a photosensitive layer-attached PET film so that the PP film and the photosensitive layer were in contact with each other, thereby obtaining a photosensitive layer-attached transfer film having a protective film.

Formation of Coating Layer

The protective film was peeled off from the photosensitive layer-attached transfer film. In addition, the surface of the copper wire-attached resin base material obtained in the step 1 was subjected to a chemical polishing treatment.

Next, the copper wire-attached resin base material and the transfer film from which the PP film had been peeled off were laminated using a vacuum laminator (“VP130” manufactured by Nikko-Materials Co., Ltd.) so that the copper wire and the photosensitive layer were in contact with each other. The pressure-bonding conditions were such that the pressure-bonding temperature was 70° C., the pressure-bonding pressure was 0.2 MPa, and the pressurizing time was 10 seconds.

As a result, a laminate in which the resin base material, the copper wire, the photosensitive layer, and the PET film (the temporary support) were laminated in this order was obtained.

A photo mask having a comb-shaped pattern was disposed on the side of the temporary support of the obtained laminate, and an exposure machine EXM-1172 for a circuit base material (manufactured by ORC MANUFACTURING CO., LTD.) was used to subject the photosensitive layer to exposure (pattern exposure) with ultraviolet rays having a wavelength of 365 nm at an exposure amount of 40 mJ/cm² (pattern exposure), through the photo mask and the temporary support, thereby curing a part of a region of the photosensitive layer.

The laminate was allowed to stand at room temperature (25° C.) for 10 minutes, and then the temporary support was peeled off from the laminate. The entire surface of the exposed photosensitive layer was subjected to spray development with an aqueous solution of 1% by mass sodium carbonate (an alkali developer, solution temperature: 30° C.) for 60 seconds at a pressure of 0.18 MPa (1.8 kgf/cm²) to dissolve and remove organic components including the resin 1 in the non-exposed portion of the photosensitive layer.

Next, both end parts of the exposed thin copper wire in the extending direction were covered with a polyimide heat-resistant tape (Kapton (registered trade name) tape), and then the surface of the laminate on the side of the copper wire was subjected to spray development with an aqueous solution of iron (III) chloride having a concentration of 5% for 30 seconds at a pressure of 0.18 MPa to dissolve and remove the copper nanowire remaining on the resin base material.

Then, the heat-resistant tape was peeled off from the laminate, and then the laminate was washed with water and dried to produce a conductive film that has a resin base material, a copper wire disposed on the resin base material and having a connecting part for a conductive connection test described later at both ends of the extending direction, and a coating layer covering the copper wire.

The conductive film was subjected to a heating treatment at 150° C. for 1 hour to cure the surface of the coating layer, whereby the hardness was increased.

The copper wire included in the conductive film had a comb-shaped pattern in which the line width is 10 μm, the space width is 20 μm, the length is 150 mm, and thirty lines (thin copper wires) are provided. In addition, the thickness of the copper wire was 0.5 μm.

As a result of observing a cross-section of the conductive film along the lamination direction using the SEM by the method described above and measuring each thickness of the coating layer based on the observation image, the thickness Tt of the apex surface part of the coating layer was 1.0 μm, and the thickness Ts of the side surface part of the coating layer was 1.0 μm.

In addition, a region for examining the conductive connectivity described later, which was not covered by the coating layer, was formed at both ends of one line (thin copper wire) constituting the comb-shaped pattern of the copper wire.

### Examples 2 to 14 and Comparative Examples 1 and 2

Conductive films of Examples 2 to 14 and Comparative Examples 1 and 2 were produced according to the procedure of Example 1, except that a composition for forming a coating layer, the composition having the raw materials and composition shown in Table 1 described later, was prepared and that the size of the photo mask, the exposure amount, and the development time at the time of the exposure of the photosensitive layer in the step 2 were adjusted.

Metal Nanowire
Copper nanowire “A2”: (manufactured by Novarials Corporation, diameter: 100 nm, length: 10 μm)
Copper nanowire “A3”: (manufactured by Novarials Corporation, diameter: 100 nm, length: 20 μm)
Copper nanowire “A20”: (manufactured by Novarials Corporation, diameter: 20 nm, length: 30 μm)
Copper nanowire “B1”: (manufactured by Novarials Corporation, diameter: 150 nm, length: 5 μm)
Copper nanowire “B2”: (manufactured by Novarials Corporation, diameter: 75 nm, length: 5 μm)

Resin
Resin solution 2: A resin solution containing the resin 2 obtained in Synthesis Example 2 below (concentration of solid contents: 40% by mass).
Resin 3: A resin 3 represented by a structural formula described below. Resin 4: A resin 4 represented by a structural formula described below Polymerizable compound
   FOM-03007: (water-soluble acrylamide monomer (N,N-bis(2-acrylamidoethyl)acrylamide), manufactured by FUJIFILM Wako Pure Chemical Corporation)

Polymerization Initiator
FOM-03011: (water-soluble radical polymerization initiator, manufactured by Fujifilm Wako Pure Chemical Corporation) Solvent
Pure water

### Synthesis Example 2: Synthesis of Acrylic Resin

Into a 1,000 mL three-necked round-bottomed flask equipped with a condenser and a stirrer, 90.6 g of 1-methoxy-2-propanol was placed, and heating was carried out to 90° C. under a nitrogen stream. To this, each of a solution of 105.8 g of benzyl methacrylate and 120.6 g of methacrylic acid dissolved in 156 g of 1-methoxy-2-propanol and a solution of 7.24 g of V-601 (an azo polymerization initiator, manufactured by Wako Pure Chemical Corporation) dissolved in 50 g of 1-methoxy-2-propanol was dropwise added over 3 hours. After completion of the dropwise addition, heating was further carried out for 1 hour to allow a reaction to proceed. Next, a solution of 2.00 g of V-601 (manufactured by Wako Pure Chemical Industries, Ltd.) dissolved in 20 g of 1-methoxy-2-propanol was added dropwise over 1 hour. After completion of the dropwise addition, heating was further carried out for 3 hours to allow a reaction to proceed, and then the heating was stopped to obtain a copolymer of benzyl methacrylate/methacrylic acid (ration in terms of % by mole: 30/70).

Next, 105.2 g of glycidyl methacrylate and 20 g of 1-methoxy-2-propanol were added to a dropping funnel, and 0.34 g of p-methoxyphenol was added to the flask, and the resultant mixture was stirred and dissolved. Next, 0.82 g of triphenylphosphine was added thereto, and the resultant mixture was heated to 100° C., and then glycidyl methacrylate was added dropwise over 1 hour from a dropping funnel to carry out an addition reaction. After confirming by gas chromatography that the glycidyl methacrylate disappeared in the flask, and the heating was stopped. Then, 45.8 g of 1-methoxy-2-propanol was added to the reaction solution.

In this way, a resin solution 2 (solid content: 45% by mass) containing an acrylic resin (a resin 2) represented by the following structural formula was prepared.

The solid content acid value of the obtained resin 2 was 121 mgKOH/g, and the weight-average molecular weight Mw thereof was 31,000. In addition, the water contact angle of a film consisting of the resin 2, where the film was formed on a glass substrate, was measured using a contact angle meter by the above-described method. As a result, the water contact angle of the film consisting of the resin 2 was 82°.

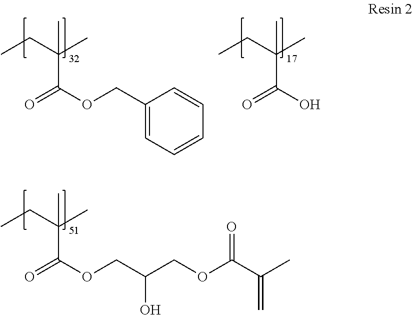

The structural formula of the resin 3 is shown below. The weight-average molecular weight Mw of the resin 3 was 210,000. In addition, as a result of measuring the water contact angle of a film consisting of the resin 3, the film being formed on a glass substrate, by using a contact angle meter by the above-described method, the water contact angle of the film consisting of the resin 3 was 57°.

In the structural formula of the resin 3 below, the numerical value at the lower right of the parentheses of each constitutional unit represents the mass ratio, and the numerical value at the lower right of the parentheses of the ethyleneoxy unit represents the repetition number.

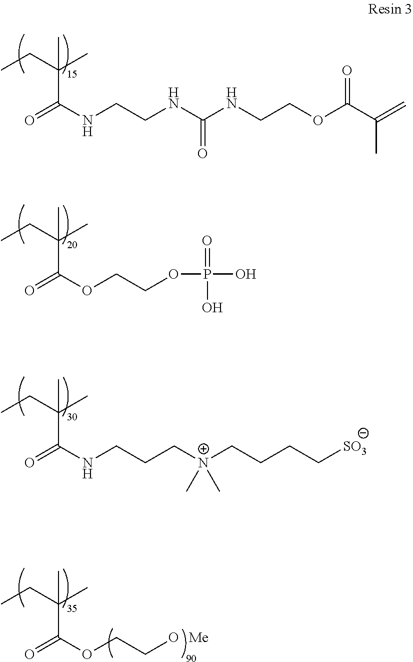

The structural formula of the resin 4 is shown below. The weight-average molecular weight Mw of the resin 4 was 100,000. In addition, as a result of measuring the water contact angle of a film consisting of the resin 4, the film being formed on a glass substrate, by using a contact angle meter by the above-described method, the water contact angle of the film consisting of the resin 4 was 49°.

In the structural formula of the resin 4 below, the numerical value at the lower right of the parentheses of each constitutional unit represents the mass ratio, and the numerical value at the lower right of the parentheses of the ethyleneoxy unit represents the repetition number.

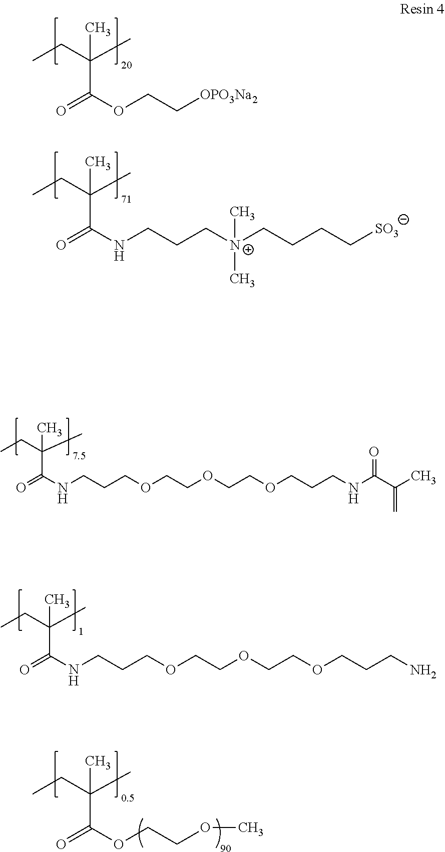

Evaluation

The conductive films of Examples 1 to 14 and Comparative Examples 1 and 2 were subjected to a storage test and a bending test in a high-temperature and high-humidity environment according to the following procedure, and then the conductivity of the copper wire was evaluated.

Storage Test in High-Temperature and High-Humidity Environment

First, the conductive film was cut into a rectangular size of a length of 100 mm and a width of 50 mm to prepare a test piece. The test piece was stored for 240 hours in an environment of a temperature of 85° C. and a relative humidity of 85%.

Bending Test

The stored test piece was subjected to a bending test using a cylindrical mandrel by a method in accordance with the bending resistance test according to the cylindrical mandrel method described in JIS-K-5600-5-1 (1999). More specifically, using a roller, the prepared test piece was bent to be wound around a cylindrical mandrel having a diameter of 2 mm. At the time when the test piece was bent, the test piece was disposed so that the resin base material, the copper wire, and the coating layer were disposed in this order from the cylindrical mandrel and the direction in which the thin copper wire extends was the direction along the circumferential direction of the cylindrical mandrel.

In the bending test, treatment was carried out ten times, where one time of treatment was defined as a process of bending the test piece and then returning the bent test piece to a flat state. In addition, the test piece was manually bent.

Conductive Connection Test

After the bending test, it was checked, regarding the 30 wires of the thin copper wire constituting the copper wire, whether or not each thin copper wire was conductively connected. Specifically, terminals of a tester (Digital Multimeter 34410A manufactured by Agil ent Technologies, Inc.) were brought into contact with both ends of each thin copper wire to carry out a conductive connection checking test of the thin copper wire, and then a case where OL (not measurable) was not displayed was evaluated to be conductively connected, and a case where OL (not measurable) was displayed was evaluated not to be conductively connected.

From the results of the conductive connectivity test carried out regarding 30 wires of the thin copper wire, the conductive connectivity (conductivity) of the conductive film was evaluated according to the following evaluation standards. In a case where the evaluation corresponded to any one of the evaluation standards 2 to 4, it was determined to be a pass level.
4: 25 or more wires of the thin copper wire were conductively connected.
3: 15 or more and 24 or fewer wires of the thin copper wire were conductively connected.
2: 5 or more and 14 or fewer wires of thin copper wire were conductively connected.
1: 1 or more and 4 or fewer wires of the thin copper wire were conductively connected, or all the thin copper wires were not conductively connected.

Table 1 below summarizes the composition of the composition for forming a coating layer, the measurement results for the conductive base material produced in each example of the coating layer to be formed, and the evaluation results of the above-described evaluation test.

In the table, the numerical value in the column of each component excluding the metal nanowire indicates the content (unit: % by mass) of each component with respect to the total mass of the composition for forming a coating layer.

In the table, the column of “Amount A (% by mass)” of “Metal nanowire” indicates the content (unit: % by mass) of the metal nanowire with respect to the total mass of the composition for forming a coating layer, and the column of “Amount B (% by mass)” indicates the content (unit: % by mass) of the metal nanowire with respect to the total mass of the coating layer.

In the table, the column of “Tt (μm)” of “Coating layer” indicates the thickness Tt (unit: μm) of the apex surface part of the coating layer, and the column of “Ts (μm)” indicates the thickness Ts (unit: μm) of one of the side surface parts of the coating layer.

TABLE 1

| | | Example | Example | Example | Example | Example | Example | Example | Example |
|---|---|---|---|---|---|---|---|---|---|
| | | 1 | 2 | 3 | 4 | 5 | 6 | 7 | 8 |
| Metal | Kind | A1 | A2 | A3 | A20 | B1 | B2 | A20 | A20 |
| nanowire | Amount A | 10.0 | 10.0 | 10.0 | 10.0 | 10.0 | 10.0 | 4.0 | 8.0 |
| | (% by mass) | | | | | | | | |
| | Amount B | 25.0 | 25.0 | 25.0 | 25.0 | 25.0 | 25.0 | 10.0 | 20.0 |
| | (% by mass) | | | | | | | | |
| Resin | Resin | 44.2 | 44.2 | 44.2 | 44.2 | 44.2 | 44.2 | 53.0 | 47.1 |
| | solution 1 | | | | | | | | |
| | Resin | — | — | — | — | — | — | — | — |
| | solution 2 | | | | | | | | |
| | Resin 3 | — | — | — | — | — | — | — | — |
| | Resin 4 | — | — | — | — | — | — | — | — |
| Polymerization | A-DCP | 7.25 | 7.25 | 7.25 | 7.25 | 7.25 | 7.25 | 8.69 | 7.73 |
| compound | FOM-03007 | — | — | — | — | — | — | — | — |
| Polymerization | Omnirad 907 | 0.82 | 0.82 | 0.82 | 0.82 | 0.82 | 0.82 | 0.98 | 0.87 |
| initiator | FOM-03011 | — | — | — | — | — | — | — | — |
| Additive | Melamine | 0.22 | 0.22 | 0.22 | 0.22 | 0.22 | 0.22 | 0.26 | 0.23 |
| | YDF-170 | 3.96 | 3.96 | 3.96 | 3.96 | 3.96 | 3.96 | 4.76 | 4.23 |
| | DETX-S | 0.00684 | 0.00684 | 0.00684 | 0.00684 | 0.00684 | 0.00684 | 0.00820 | 0.00729 |
| | MEGAFAC | 0.273 | 0.273 | 0.273 | 0.273 | 0.273 | 0.273 | 0.328 | 0.292 |
| | EF-780F | | | | | | | | |
| Solvent | Cyclohexane | 33.3 | 33.3 | 33.3 | 33.3 | 33.3 | 33.3 | 28.0 | 31.5 |
| | Water | — | — | — | — | — | — | — | — |
| Solid content (% by mass) | | 40.0 | 40.0 | 40.0 | 40.0 | 40.0 | 40.0 | 40.0 | 40.0 |
| Coating layer | Tt(μm) | 1.0 | 1.0 | 1.0 | 1.0 | 1.0 | 1.0 | 1.0 | 1.0 |
| | Ts(μm) | 1.0 | 1.0 | 1.0 | 1.0 | 1.0 | 1.0 | 1.0 | 1.0 |
| Condutice connectivity after | | 3 | 3 | 3 | 4 | 4 | 3 | 3 | 4 |
| bending test | | | | | | | | | |
| | | Example | Example | Example | Example | Example | Example | comparative | comparative |
| | | 9 | 10 | 11 | 12 | 13 | 14 | example 1 | example 2 |
| Metal | Kind | A20 | A20 | A20 | A20 | A20 | A1 | — | A1 |
| nanowire | Amount A | 12.0 | 16.0 | 10.0 | 10.0 | 10.0 | 10.0 | — | 10.0 |
| | (% by mass) | | | | | | | | |
| | Amount B | 30.0 | 40.0 | 25.0 | 25.0 | 25.0 | 25.0 | — | 25.0 |
| | (% by mass) | | | | | | | | |
| Resin | Resin | 41.2 | 35.3 | 44.2 | 44.2 | 44.2 | — | — | — |
| | solution 1 | | | | | | | | |
| | Resin | — | — | — | — | — | 55.4 | 73.8 | — |
| | solution 2 | | | | | | | | |
| | Resin 3 | — | — | — | — | — | — | — | 4.4 |
| | Resin 4 | — | — | — | — | — | — | — | 4.4 |
| Polymerization | A-DCP | 6.76 | 5.80 | 7.25 | 7.25 | 7.25 | — | — | — |
| compound | FOM-03007 | — | — | — | — | — | — | — | 20.00 |
| Polymerization | Omnirad 907 | 0.77 | 0.66 | 0.82 | 0.82 | 0.82 | 0.82 | 1.09 | — |
| initiator | FOM-03011 | — | — | — | — | — | — | — | 1.20 |
| Additive | Melamine | 0.20 | 0.17 | 0.22 | 0.22 | 0.22 | 0.22 | 0.29 | — |
| | YDF-170 | 3.70 | 3.17 | 3.96 | 3.96 | 3.96 | 3.96 | 5.29 | — |
| | DETX-S | 0.00638 | 0.00547 | 0.00684 | 0.00684 | 0.00684 | 0.00684 | 0.00911 | — |
| | MEGAFAC | 0.255 | 0.219 | 0.273 | 0.273 | 0.273 | 0.273 | 0.365 | — |
| | EF-780F | | | | | | | | |
| Solvent | Cyclohexane | 35.1 | 38.7 | 33.3 | 33.3 | 33.3 | 29.4 | 19.2 | — |
| | Water | — | — | — | — | — | — | — | 60.0 |
| Solid content (% by mass) | | 40.0 | 40.0 | 40.0 | 40.0 | 40.0 | 40.0 | 40.0 | 40.0 |
| Coating layer | Tt(μm) | 1.0 | 1.0 | 0.5 | 5.0 | 7.5 | 1.0 | 1.0 | 1.0 |
| | Ts(μm) | 1.0 | 1.0 | 3.0 | 5.0 | 7.5 | 1.0 | 1.0 | 1.0 |

| | | | | | | | | |
|---|---|---|---|---|---|---|---|---|
| Condutice connectivity after | 4 | 3 | 4 | 4 | 3 | 2 | 1 | 1 |
| bending test | | | | | | | | |

The conductive films of Examples 1 to 14 contain a resin base material, a copper wire that is disposed on the resin base material, and a coating layer that covers a surface of the copper wire, where the coating layer contains a hydrophobic resin and a metal nanowire. It has been confirmed that in such a conductive film, the conductive connectivity of the conductive film is maintained even in a case where a bending test is carried out after the conductive film is stored in a high-temperature and high-humidity environment. This is presumed to be because the coating layer contains a hydrophobic resin, and thus the watery moisture absorption of the coating layer is suppressed and the conductivity of the metal nanowire is maintained even during storage in a high-temperature and high-humidity environment, and as a result, the electrical connection between both ends of the thin copper wire is maintained by the metal nanowire of the coating layer even in a case where the cracking or disconnection of the thin copper wire has occurred in the subsequent bending test.

On the other hand, the evaluation of the conductive film of Comparative Example 1 corresponds to the evaluation standard 1, which is inferior to that of Examples. It is presumed that since the coating layer does not contain the metal nanowire, the conductive connectivity cannot be maintained in the thin copper wire in which cracking or disconnection has occurred at the time of the bending test.

The evaluation of the conductive film of Comparative Example 2 corresponds to the evaluation standard 1, which is inferior to that of Examples. It is presumed that since the coating layer does not contain the hydrophobic resin but contains the hydrophilic resin, the coating layer absorbs water during storage in a high-temperature and high-humidity environment, and the metal nanowire undergoes deterioration (corrosion and the like), which results in the decrease in the function of maintaining the conductive connectivity of the thin copper wire in which cracking or disconnection has occurred due to the bending test.

From the above, it has been confirmed that according to the present invention, it is possible to provide a conductive film having excellent conductivity even in case where a bending test is carried out after the storage in a high-temperature and high-humidity environment.

It has been confirmed that the effect of the present invention is more excellent in a case where the hydrophobic resin includes a polyurethane resin (comparison between Examples 1 to 14).

It has been confirmed that the effect of the present invention is more excellent in a case where the content of the metal nanowire is 20% to 30% by mass with respect to the total mass of the coating layer (comparison between Examples 4 and 7 to 10).

### EXPLANATION OF REFERENCES

10: conductive film
12: resin base material
14: copper wire
14a, 14B: thin copper wire (thin wire-shaped member)
14t: apex surface
14s: side surface
16: coating layer
16t: apex surface part
16s: side surface part
20: opening portion

What is claimed is:

1. A conductive film comprising:
a resin base material;
a copper wire that is disposed on the resin base material; and
a coating layer that covers a surface of the copper wire,
wherein the coating layer contains a metal nanowire and a hydrophobic resin.

2. The conductive film according to claim 1,
wherein the metal nanowire contains copper.

3. The conductive film according to claim 1,
wherein the metal nanowire has a diameter of 20 to 150 nm.

4. The conductive film according to claim 1,
wherein the metal nanowire has a length of 5 to 200 μm.

5. The conductive film according to claim 1,
wherein a content of the metal nanowire is 10% to 40% by mass with respect to a total mass of the coating layer.

6. The conductive film according to claim 1,
wherein the hydrophobic resin has a tricyclodecane structure.

7. The conductive film according to claim 1,
wherein the hydrophobic resin includes a polyurethane resin.

8. The conductive film according to claim 1,
wherein a thickness of a region of the coating layer, the region being disposed on a surface of the copper wire on a side opposite to a surface facing the resin base material, is 1 to 10 μm.

9. The conductive film according to claim 1,
wherein a thickness of a region of the coating layer, the region including a direction in which the copper wire extends and being disposed on a surface intersecting a surface facing the resin base material, is 1 to 10 μm.
